(19) United States
(12) Patent Application Publication
(10) Pub. No.: US 2007/0021253 A1
(43) Pub. Date: Jan. 25, 2007

(54) Belt tensioning device

(76) Inventors: Vladimir Kobelev, Attendorn (DE); Manfred Jung, Westerburg (DE); Rudolf Berger, Simmerath (DE)

Correspondence Address: Wyatt, Gerber & O'Rourke, LLP, 99 Park Avenue, New York, NY, 10016, US

(21) Appl. No.: 11/474,592

(22) Filed: Jun. 26, 2006

(30) Foreign Application Priority Data
Jun. 24, 2005 (DE) 102005029753.6-12

(51) Int. Cl. F16H 7/12; F16H 7/14

(52) U.S. Cl. 474/135; 474/133; 474/117

(57) ABSTRACT

A belt tensioning device fixable to a unit has a torsion spring assembly. A housing is provided with a longitudinal axis A and a torsion spring is positioned in the housing so as to extend coaxially relative to the longitudinal axis A. One of the ends of the torsion spring is secured to the housing in a rotationally fixed way. A tensioning arm is supported relative to the housing so as to be oscillatingly rotatable around the longitudinal axis A. The tensioning arm is connected to the other end of the torsion spring in a rotationally fixed way. A tensioning roller is supported at a free end of the tensioning arm supported so as to be rotatable around an axis of rotation B extending parallel relative to the longitudinal axis A. The housing has a flange for being fixed to the unit, whose flange plane is passed through by the longitudinal axis A.

### FIELD OF THE INVENTION

The invention relates to a belt tensioning device for being fixed to a unit and has a torsion spring assembly. The torsion spring assembly has a housing with a longitudinal axis and a torsion spring which is positioned in the housing. The torsion spring assembly extends coaxially relative to the longitudinal axis and which, by means of one of its ends, is secured to the housing in a rotationally fixed way. A tensioning arm is supported relative to the housing so as to be oscillatingly rotatable around the longitudinal axis and is connected to the other end of the torsion spring in a rotationally fixed way. The tensioning arm has a tensioning roller which, at a free end of the tensioning arm, is supported so as to be rotatable around an axis of rotation extending parallel relative to the longitudinal axis. Such belt tensioning devices are used together with belt drives which comprise at least two belt pulleys and a continuous belt running over the same. One of the belt pulleys is a driving pulley wherein the tensioning roller of the belt tensioning device acts on the slack side of the continuous belt to compensate for changes in length of the belt and to ensure that the belt does not jump off the belt pulleys. The belts can be the now commonly used cogged belts or V-belts. When replacing the belt pulleys and the tensioning roller by chain wheels, the device can, analogously, also be used for chain drives.

A typical application of belt drives is in the drive of auxiliary units of internal combustion engines, wherein a first belt pulley is positioned on the crankshaft and serves as a driving pulley. Additional belt pulleys are positioned on the shafts of auxiliary units such as a water pump, generator, air conditioning plant, compressor, etc and are driven by the belt drive. In such applications, there occurs a belt slack in the direction of rotation behind the driving belt pulley. This slack has to be compensated for by the tensioning roller so that the belt does not jump off the belt pulleys. In operation and under the influence of temperature, the belt length changes, so that the tensioning arm with the tensioning roller has to act on the belt slack under spring pretension. To ensure that the movements of the tensioning arm and of the belt do not change into oscillating movements, there is provided a damping device for such movements of the tensioning arm. The axis of rotation and oscillation of the tensioning arm extends parallel to the axes of rotation of the belt pulley and of the tensioning roller.

### BACKGROUND OF THE INVENTION

From European Publication Document EP 1 420 193 A2 there is known a tensioning device wherein at a housing tube there are attached two axially spaced eyes by means of which the housing can be bolted to the face of a unit. The face extends parallel to the longitudinal axis of the housing. This requires a free space on the side of a unit, more particularly with internal combustion engine at whose end there is the associated belt drive of the belt pulleys and the tensioning roller.

German Publication Document DE 29 12 944 A1 describes a belt tensioning device wherein there is provided a holding bracket which is intended for the torsion spring at the housing tube end axially opposed to the tensioning arms and which extends radially relative to the longitudinal axis of the housing. The housing of the belt tensioning device is subject to bending loads.

### OBJECT OF THE INVENTION

It is the object of the present intention to provide a belt tensioning device which, while being very robust, offers advantageous fixing possibilities. The objective is achieved by a belt tensioning device which has a housing with a flange for being fixed to a unit. The flange plane is passed through by the longitudinal axis A. More particularly, it is proposed that the flange plane extend normally relative to the longitudinal axis A. The flange may be provided in the form of an annular flange which can be radially welded to the tubular housing. This constitutes a simple connection with a high degree of stability. By providing the fixing means for the belt tensioning device at the unit in the form of a flange passed through by the longitudinal axis, it is possible to arrange the belt tensioning device from the end face of the unit on to which the belt drive has been clamped. For fixing purposes, there is required a small basal face only of the size of the flange. More particularly, the flange can be axially arranged so as to directly adjoin a bearing eye of the tensioning arm, so that the housing is supported near the load application plane of the tensioning arm. In this way, the housing is largely kept free from bending forces.

### SUMMARY OF THE INVENTION

According to a first embodiment, the flange can be provided with two or three through-holes for example which can be passed through by bolts which can be threaded into a flange face of the unit on which unit flange face the housing flange is supported. In a simplified embodiment, it is possible to insert a pin into the flange to ensure that the flange does not rotate relative to the unit. This pin engages a first flange bore in the unit, so that there is required only one single through-hole in the flange for inserting a bolt which is threaded into a flange face of the unit. It is thus possible to securely connect the entire belt tensioning device to the unit by threading in one single screw.

According to a second embodiment, an axial tensioning bush for tensioning the flange at the unit is arranged at the housing at the axially opposite end of the housing with respect to the flange. In such a case, the housing flange is designed as purely a supporting flange for resting at the flange face of the unit. This supporting flange is used in combination with a tensioning sleeve which is threaded on to the housing end axially opposite the tensioning arm and which sleeve is supported on the unit in the opposite direction than the supporting flange. In this case the belt tensioning device with the housing is made to pass through a portion of the unit or a corresponding part attached to the unit and tensioned in the direction of the longitudinal axis A of the housing. In this case, too, the belt tensioning device is arranged from the unit end which carries the associated belt drive. In the above-mentioned embodiment, too, a robust connection can be achieved by threading in one single bolt if additional anti-rotation means for the flange are provided, i.e. in the form of a pin.

A preferred embodiment for the friction damping device consists of the friction damping device arranged on the housing to generate friction relative thereto while being supported in the direction of rotation in the bearing eye of the tensioning arm. A second advantageous embodiment of the friction damping device is arranged on the outside on the bearing eye of the tensioning arm and is supported in the direction of rotation on the unit.

As is obvious from the above, the invention also relates to a unit with a belt tensioning device of this type which is characterised by the unit comprising a housing recess with a surrounding flange face into which there is inserted the housing of the belt tensioning device. The housing flange is fixed to the flange face of the unit, more particularly threaded to the flange face of the unit. Furthermore, the invention relates to a unit with a belt tensioning device of this type which is characterised by the unit comprising a housing recess with a surrounding flange face into which the housing of the belt tensioning face is inserted. The housing flange is supported on the flange face of the unit and the housing is axially tensioned by tensioning means against the unit. The tensioning means comprise, more particularly, an axial tensioning sleeve positioned on the housing end which is axially opposed to the tensioning arm and flange respectively and which is axially supported on the unit in the direction opposed to the direction of support of the housing flange.

Preferred embodiments are further described in sub-claims to which reference is hereby made.

In all the above-mentioned embodiments, the torsion spring is preferably provided in the form of a bundle of spring bars the ends of which are form-fittingly inserted into bushes which, in turn, are either directly or indirectly connected to the housing on the one hand and to the tensioning arm on the other hand.

### BRIEF DESCRIPTION OF THE DRAWINGS

Preferred embodiments of the invention are illustrated in the figures and will be described below.

FIG. 1 illustrates the inventive belt tensioning device in a first embodiment in a longitudinal section.

FIG. 2 illustrates a device according to FIG. 1 in a cross-section B-B.

FIG. 3 illustrates a device according to FIG. 1 in a cross-section C-C.

FIG. 4 illustrates the inventive belt tensioning device in a second embodiment in a longitudinal section.

FIG. 5 illustrates a device according to FIG. 4 in a cross-section B-B.

FIG. 6 illustrates a device according to FIG. 4 in a cross-section C-C.

FIG. 7 illustrates the inventive belt tensioning device in a third embodiment in a longitudinal section.

FIG. 8 illustrates a device according to FIG. 7 in a cross section.

FIG. 9 illustrates a device according to FIG. 8 with supporting means.

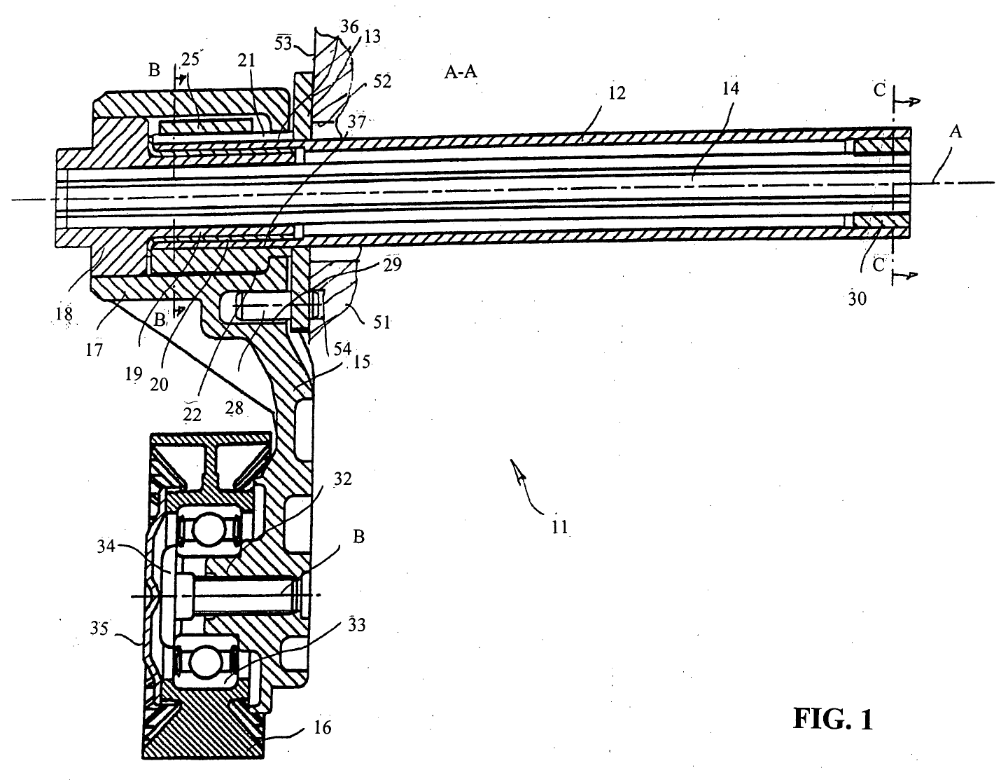

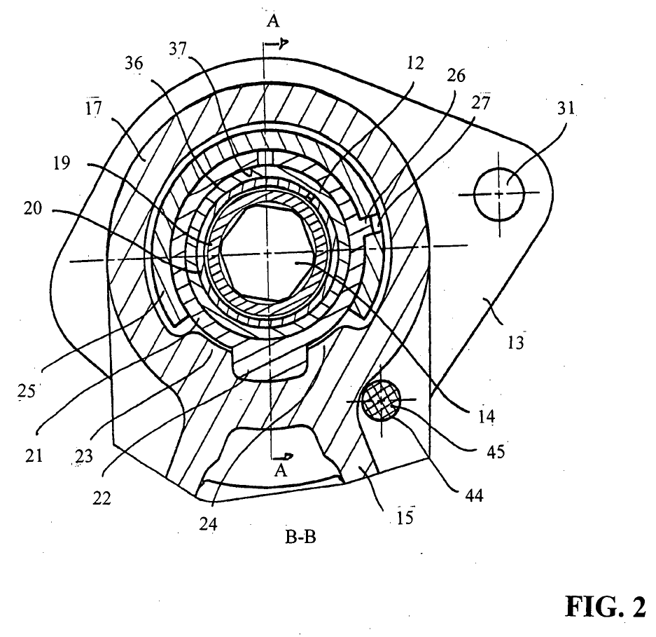

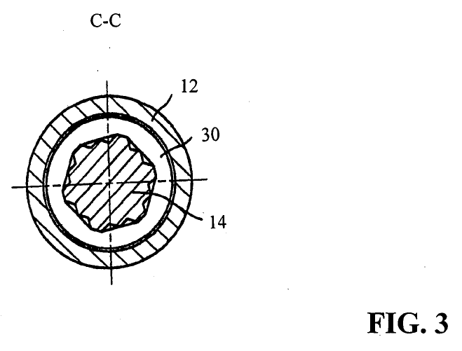

FIGS. 1 to 3 will be described jointly below. An inventive belt tensioning device 11 comprises a tubular housing 12 with a longitudinal axis A to the outside of which there is attached a fixing flange 13 in which there is positioned a torsion spring 14. A tensioning arm 15 oscillates around the longitudinal axis A and a tensioning roller 16 is rotatable at the free end of the tensioning arm around an axis of rotation B extending parallel relative to the longitudinal axis A. The tensioning arm 15 comprises a bearing eye 17 into which there is inserted a plug 18. The plug 18 comprises a sleeve projection 19 which engages the housing 12 and is rotatably supported therein y means of a friction bearing bush 20. By means of a plug 30 firmly inserted into the housing, the torsion spring 14 is connected in a rotationally fixed way to one end of the housing 12. The other end of the torsion spring 14 is connected in a rotationally fixed way to the plug 18 and thus to the tensioning arm 15.

On the housing 12, inside the bearing eye 17, there is positioned a circumferentially slotted damping sleeve 21. By means of an outer rib 22 the bearing eye 17 is held in a rotationally fixed way between two rib holding devices 23, 24 in the bearing eye 17. The friction sleeve 21 is surrounded by a spring sleeve 25 which is also circumferentially slotted and which is radially pretensioned relative to the friction sleeve 21. By means of an inwardly directed radial pretension, the spring sleeve 25 holds the slotted friction sleeve 21 on the cylindrical housing 12 in position. The spring sleeve 25 is circumferentially form-fittingly and positively fixed relative to the friction sleeve 21 by a radial knob 26 which engages a suitably shaped hole 27 in the spring sleeve 25.

The fixing flange 13 can be seen to comprise an abutment pin 28 which engages a circumferentially extending oblong hole 29 in the tensioning arm 15. This structure delimits the relative pivot movement of the tensioning arm 15 relative to the fixing flange 13 and thus relative to the housing 12. Furthermore, in the fixing flange 13 there can be seen one of several fixing holes 31 for threading-on the fixing flange 13 by means of bolts to a unit.

Furthermore, at the outer end of the tensioning arm 15 there can be seen a journal attachment 32 on which there is supported the tensioning roller 16 by means of a deep groove ball bearing 33. The deep groove ball bearing 33 is secured by a bolt 34 on the journal attachment 32. For the purpose of sealing the deep groove ball bearing 33, a cover 35 is inserted into the tensioning roller 16. A securing pin 45 is inserted into a bore 44 in the tensioning arm 15 and passes through a corresponding bore in the fixing flange 13 and, for assembly purposes, holds the tensioning arm 15 in a greatly pretensioned position relative to the fixing flange.

As can be seen in detail in FIG. 1, the housing 12 (only partially illustrated) is inserted into a housing aperture 52 in the unit 51. The flange 13 rests against a flange face 53 in the unit 51, which flange face 53 points towards the end face of the unit 51. The entire belt drive is spread across to the end face. For preventing the flange from rotating, the pin 28 which passes through the flange 13 engages a countersunk portion 54 in the flange face 53. The flange 13 is clamped to the unit 51 by a bolt which cannot be seen in this sectional plane, which passes through the through-aperture 31 and is threaded into a threaded hole in the flange face 52.

The above-described design results in the following function of the belt tensioning device. The tensioning arm 15 with the bush 19 is pivotable relative to the housing 12 secured by the flange 13 around the longitudinal axis A. In the case of a pivot movement, the torsion spring 14 which, on the one hand, is secured in the plug 30 and thus in the housing 12 and, on the other hand, in the bush 19. Thus the tensioning arm 15 will be twisted against elastic returning forces. In the mounted condition, it is possible for the torsion spring 14 to be held in a greatly pretensioned twisted position. Each pivot movement of the tension arm 15 relative to the housing 12 generates a friction on the sleeve 21 which is tensioned radially inwardly by the flat spring 25 relative to the housing 12 in the friction face pair 36, 37 so that the oscillating movement of the tension arm is dampened. As can be seen in FIGS. 1, 2 and 3, the plugs 18, 30 each comprise a polygonal inner contour in which the torsion spring 14 is received in a form-fitting and positive way. The torsion spring 14 can be composed of a bundle of individual parallel spring bars which are not shown.

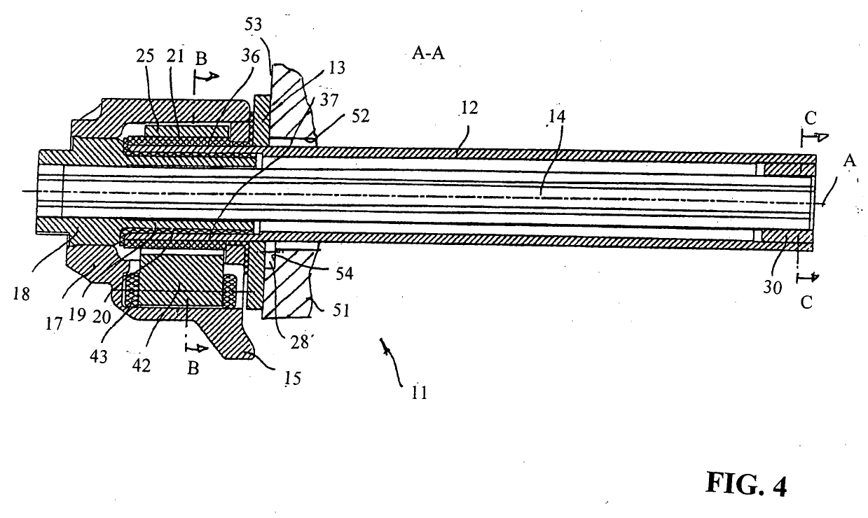

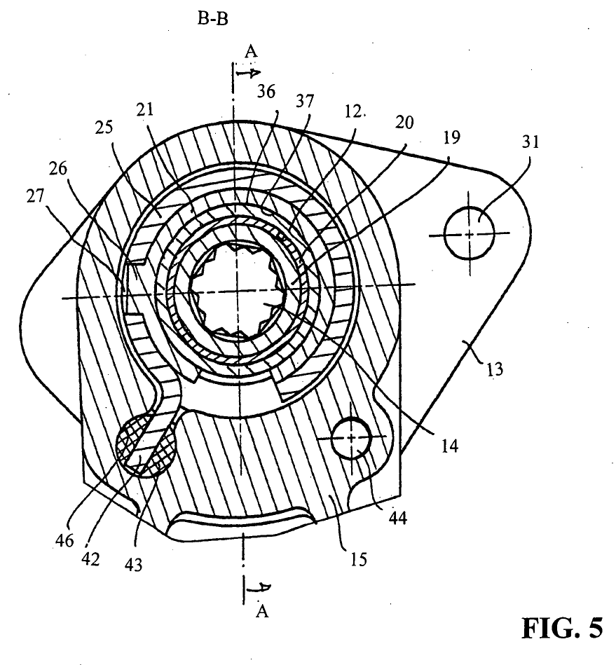

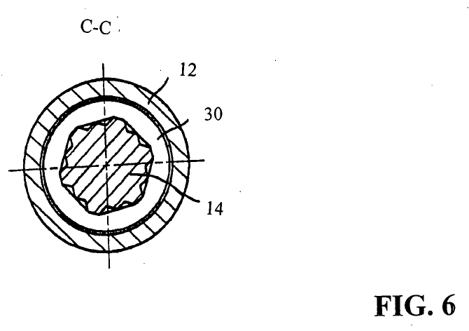

FIGS. 4 to 6 will be described jointly below. An inventive belt tensioning device 11 comprises a tubular housing 12 with a longitudinal axis A to-the outside of which there is attached a fixing flange 13′ and in which there is positioned a torsion spring 14. A tensioning arm 15 oscillates around the longitudinal axis A. A tensioning roller is rotatable at the free end of the tensioning arm around an axis of rotation extending parallel relative to the longitudinal axis A. In FIGS. 4 and 5, the tensioning arm 15 is shown in a broken-off condition. It can be designed analogously to the tensioning arm illustrated in FIG. 1. The tensioning arm 15 comprises a bearing eye 17 into which there is inserted a plug 18. The plug 18 comprises a sleeve projection 19 which engages the housing 12 and is rotatably supported therein by means of a friction bearing bush 20. A plug 30 firmly inserted into the housing connects the torsion spring 14 in a rotationally fixed way to one end of the housing 12. The other end of the torsion spring 14 is connected in a rotationally fixed way to the plug 18 and thus to tensioning arm 15.

On the housing 12, inside the bearing eye 17, there is positioned a circumferentially slotted damping sleeve 21. The friction sleeve 21 is surrounded by a spring sleeve 25 which is also circumferentially slotted and which is radially pretensioned relative to the friction sleeve 21 and thus, via an inwardly directed radial pretension, holds the slotted friction sleeve on the cylindrical housing 12 in position. The spring sleeve 25 is circumferentially form-fittingly and positively secured relative to the tensioning arm 15 by means of a radially outwardly bent bracket 42 which engages a pocket 46 in the tensioning arm 15, with a rubber-elastic damping element 43 being inserted between the two. The damping sleeve 21 is held in a rotationally fixed way in the spring sleeve 25, by a radial knob 26 which engages a correspondingly shaped hole 27 in the spring sleeve 25. In the fixing flange 13 there can be seen one of several fixing holes 31 for threading the fixing flange 13 by means of bolts on to a unit. Furthermore, in the fixing flange there is provided a bore 44 for receiving a securing pin for assembly purposes whose function has already been described in connection with the first embodiment.

As can be seen in FIG. 4, the housing 12 (illustrated only partially) has been inserted into a housing aperture 52 of a unit 51. The flange 13 rests against a flange face 53 of the unit 51 which surrounds the housing aperture 52. To prevent the flange 13 from rotating, a pin 28′ attached to the flange 13 engages a countersunk portion 54′ in the flange face 53 of the unit 51. The belt tensioning device is clamped to the unit 51 by means of a bolt (not shown in the section) which passes through the bolt hole 31 in the flange 13.

The above-described design results in the following function of the belt tensioning device. The tensioning arm 15 with the bush 19 is pivotable around the longitudinal axis A relative to the housing 12 secured by the flange 13. In the case of a pivot movement, the torsion spring 14 which, on the one hand, is secured in the plug 30 and thus in the housing 12 and, on the other hand, in the bush 19 and thus in the tensioning arm 15 is twisted against elastic returning forces. In the mounted condition, it is possible for the torsion spring 14 to be held in a greatly pretensioned twisted position. Each pivot movement of the tension arm 15 relative to the housing 12 generates a friction on the friction sleeve 21 which is radially pretensioned by the flat spring 25 relative to the housing 12 in the friction face pair 36, 37, so that the oscillating movement of the tension arm is dampened.

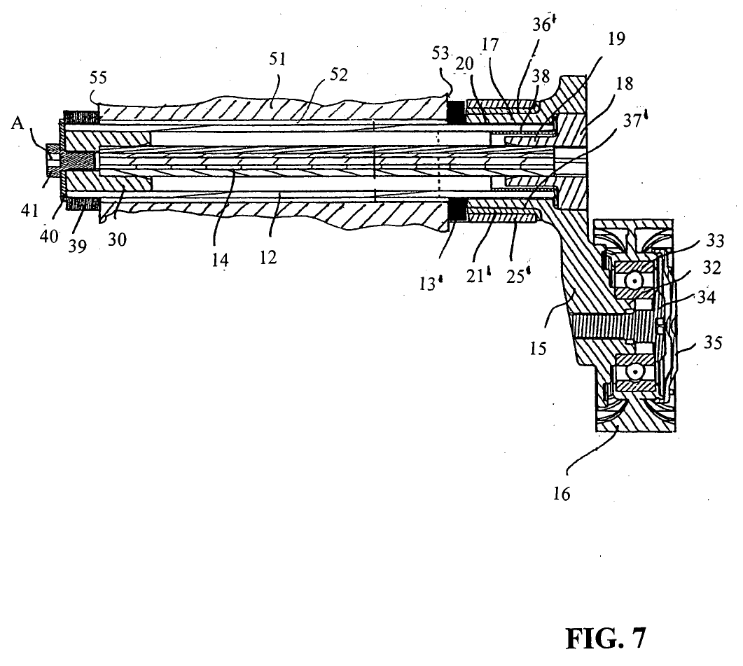

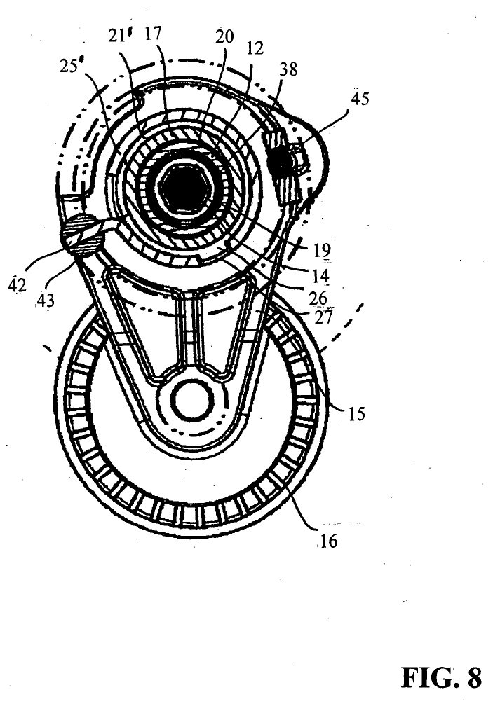

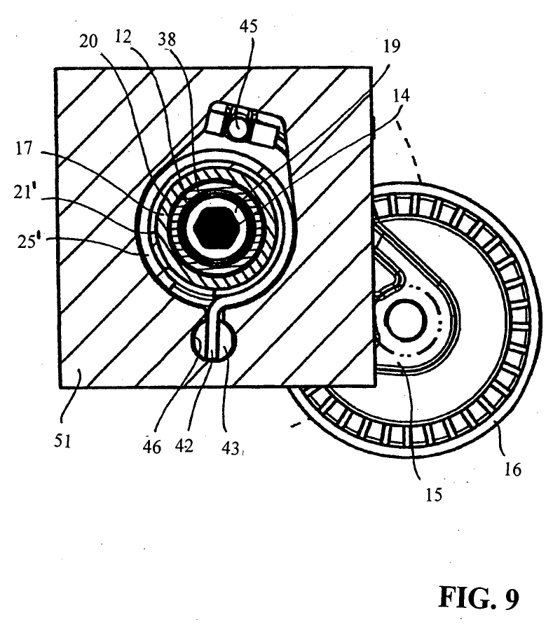

FIGS. 7 to 9 will be described jointly below. An inventive belt tensioning device 11 comprises a tubular housing 12 with a longitudinal axis A to the outside of which there is attached a fixing flange 13′ and in which there is positioned a torsion spring 14. A tensioning arm 15 oscillates around the longitudinal axis A. A tensioning roller 16 is rotatable at the free end of the tensioning arm around an axis of rotation B extending parallel relative to the longitudinal axis A. The tensioning arm 15 comprises a bearing eye 17 into which there is inserted a plug 18. The bearing eye 17′ is directly rotatably supported on the housing 12 by a friction bearing bush 20′. The plug 18 comprises a sleeve projection 19 which engages the housing 12 and is sealed relative thereto by a sealing sleeve 38. A plug 30 is firmly inserted into the housing and the torsion spring 14 is connected in a rotationally fixed way to one end of the housing 12. The other end of the torsion spring 14 is connected in a rotationally fixed way to the sleeve projection 39 of the plug 18 and thus to the tensioning arm 15. On the bearing eye 17′, there is positioned a circumferentially slotted damping sleeve 21. The friction sleeve 21 is surrounded by a spring sleeve 25′ which is also circumferentially slotted and which is radially pretensioned relative to the friction sleeve 21′. The radial pretension, holds the slotted friction sleeve on the bearing eye 17′ in position. The spring sleeve 25′ is circumferentially form-fittingly secured relative to the friction sleeve 21′. A radial knob 26 engages a correspondingly shaped hole 27 in the flat spring 25′.

The fixing flange 13′ is a supporting flange and comprises only anti-rotation means relative to a supporting face of a unit or of an assembly to be fixed on. At the free end of the housing, there is provided an axial tensioning sleeve 39 which can be tensioned by means of a disc 40 and a bolt 41 threaded into the sleeve 21 in such a way that the housing 12 can be clamped into a unit or into an assembly to be fixed on, into which it has been inserted. A bracket 42 at the spring sleeve 25′ which is radially bent has to be secured in a pocket 46 of the fixing housing, with a rubber-elastic damping element 43 being inserted between the two. Furthermore, at the outer end of the tensioning arm 15 there is provided a journal attachment 32 on which there is supported the tensioning roller 16 by means of a deep groove ball bearing 33, with the bearing being secured by a bolt 34 on the journal attachment 32. For sealing the deep groove ball bearing 33, a cover 35 has been inserted into the tensioning roller 16.

As can be seen in FIG. 7, the housing tube 12 has been inserted through a housing bore 52 of the unit 51 shown in a broken-off condition. The flange 13′ is supported on a flange face 53 and the tensioning bolt 39 is supported on a flange face 55 extending in the opposite direction. The belt tensioning device is clamped into the unit 51, with the mounting procedure taking place from the end face of the unit 51 across which end face the belt drive extends and which is defined by the position of the flange face 53.

The above-described design results in the following function of the belt tensioning device. The tensioning arm 15 with the bush 19 is pivotable around the longitudinal axis A relative to the housing 12 secured by the flange 13 and the sleeve 39. In the case of a pivot movement, the torsion spring 14 which, on the one hand, is secured in the plug 30 and thus in the housing 12 and, on the other hand, in the plug 18 and thus in the tensioning arm 15 is twisted against elastic returning forces. In the mounted condition, it is possible for the torsion spring 14 to be held in an already greatly pretensioned twisted position. Each pivot movement of the tension arm 15 relative to the housing 12 generates a friction on the fixed friction sleeve 21 which is radially pretensioned by the flat spring 25 relative to the bearing eye 17′ which is moved together with the tensioning arm 15, so that the oscillating movement of the tension arm is dampened.

I claim:

1. A belt tensioning device for being fixed to a unit, comprising a torsion spring assembly, a housing with a longitudinal axis, a torsion spring which is positioned in said housing so as to extend coaxially relative to said longitudinal axis and wherein one of its ends is secured to the housing in a rotationally fixed way, a tensioning arm is supported relative to said housing so as to be oscillatingly rotatable around said longitudinal axis and which is connected to the other end of said torsion spring in a rotationally fixed way; a tensioning roller which, at a free end of said tensioning arm, is supported so as to be rotatable around an axis of rotation (B) extending parallel relative to the longitudinal axis (A), and wherein on said housing there is arranged a flange for being fixed to said unit, whose flange plane is passed through by said longitudinal axis (A).

2. A device according to claim 1, wherein said flange plane extends normally relative to the longitudinal axis (A).

3. A device according to claims 1 or 2, wherein said flange is provided in the form of an annular flange and, more particularly, is welded to said housing.

4. A device according to any one of claims 1 or wherein said housing is provided in the form of a tubular member.

5. A device according to any one of claims 1 or 2, wherein said flange is arranged so as to axially adjoin a bearing eye of said tensioning arm.

6. A device according to any one of claims 1 or 2, wherein an abutment pin is attached to said flange so as to extend parallel to said longitudinal axis (A), said abutment pin being a rotational stop, cooperating with a circular-arch-shaped oblong hole recess in said tensioning arm.

7. A device according to any one of claims 1 or 2, wherein said flange has one or more through-holes for being threaded on to said unit.

8. A device according to any one of claims 1 or 2, wherein an axial tensioning bush for tensioning said flange at said unit is arranged at said housing at the axially opposite end of said flange.

9. A device according to any one of claims 1 or 2, wherein on said housing, there is arranged a friction damping device which, in the direction of rotation, is supported in a bearing eye of said tensioning arm.

10. A device according to any one of claims 1 or 2, wherein on said bearing eye of said tensioning arm, there is arranged a friction damping device which, in the direction of rotation, is supported on said unit.

11. A unit with a belt tensioning device fixed thereto having a torsion spring assembly; a housing with a longitudinal axis; a torsion spring which is positioned in said housing so as to extend coaxially relative to the longitudinal axis (A) and which, by means of one of its ends, is secured to said housing in a rotationally fixed way; a tensioning arm which is supported relative to said housing so as to be oscillatingly rotatable around said longitudinal axis (A) and which is connected to the other end of said torsion spring in a rotationally fixed way; a tensioning roller which, at a free end of said tensioning arm, is supported so as to be rotatable around an axis of rotation (B) extending parallel relative to the longitudinal axis (A), wherein said unit comprises a housing recess with a surrounding flange face into which there is inserted said housing of the belt tensioning device, wherein said housing flange is secured to said flange face of said unit.

12. A unit according to claim 11, wherein said housing flange is threaded to said flange face of said unit.

13. A unit with a belt tensioning device fixed thereto having a torsion spring assembly, a housing with a longitudinal axis (A), a torsion spring which is positioned in said housing so as to extend coaxially relative to the longitudinal axis (A) and which, by means of one of its ends, is secured to said housing in a rotationally fixed way; a tensioning arm which is supported relative to said housing so as to be oscillatingly rotatable around the longitudinal axis (A) and which is connected to the other end of said torsion spring in a rotationally fixed way, and having a tensioning roller which, at a free end of said tensioning arm, is supported so as to be rotatable around an axis of rotation (B) extending parallel relative to said longitudinal axis (A), wherein said unit comprises a housing recess with a surrounding flange face into which the said housing of the belt tensioning device is inserted, and wherein said housing flange is supported on said flange face of said unit, and said housing is axially tensioned against said unit by tensioning means.

14. A unit according to claim 13, wherein said tensioning means comprise an axial tensioning sleeve which is arranged on the end of said housing and which is axially supported on said unit in the direction opposed to the direction of support of said housing flange.
